(19) United States
(12) Patent Application Publication
(10) Pub. No.: US 2024/0119598 A1
(43) Pub. Date: Apr. 11, 2024

(54) IMAGE PROCESSING SYSTEM, IMAGING DEVICE, TERMINAL DEVICE, AND IMAGE PROCESSING METHOD

(71) Applicant: Mitsubishi Electric Corporation, Tokyo (JP)

(72) Inventors: Keiji UEMURA, Tokyo (JP); Susumu IINO, Tokyo (JP); Masahide KOIKE, Tokyo (JP)

(73) Assignee: Mitsubishi Electric Corporation, Tokyo (JP)

(21) Appl. No.: 18/571,737

(22) PCT Filed: Jun. 30, 2021
(86) PCT No.: PCT/JP2021/024775

§ 371 Date: Dec. 19, 2023

(51) Int. Cl. G06T 7/11

(52) U.S. Cl. CPC G06T 7/11; G06T 2207/30242

(57) ABSTRACT

A monitoring camera includes an imaging unit that generates image data; a division processing unit that divides the image into a processible image and a target image when a processing load of image processing to be executed on the image is more than a predetermined load; an image processing unit that executes the image processing on the processible image; and a transmitting unit that transmits a first image processing result that is a result of the image processing executed on the processible image and target image data. The terminal includes: a communication unit that receives the first image processing result and the target image data; an image processing unit that executes image processing on the target image indicated by the target image data; and a managing unit that acquires one result by integrating the first image processing result and a second image processing result.

### TECHNICAL FIELD

The disclosure relates to an image processing system and an imaging device.

### BACKGROUND ART

There is a technology for processing images captured by monitoring cameras, such as recognizing subjects in real-time by processors or the like built into the monitoring cameras. With such technology, the monitoring cameras execute advanced image processing, so that the processing capability of the monitoring cameras may be insufficient depending on the content of the images that change from moment to moment.

Patent Literature 1 discloses a method of distributing processing load to other devices connected to a monitoring camera to compensate for the lack of processing capability of the monitoring camera.

### PRIOR ART REFERENCE

### Patent Reference

Patent Literature 1: Japanese Patent Application Publication No. 2014-102691

### SUMMARY OF THE INVENTION

### Problem to be Solved by the Invention

However, since a portion of the processing is transferred to other devices and these other devices execute the portion of the processing, the conventional method has a problem in that when the processing load of the portion of the processing to be transferred is high, the processing load of the devices executing the portion of the processing becomes high, and the device that was originally supposed to execute that portion of the processing results in having a spare processing load.

Accordingly, an object of one or more aspects of the disclosure is to fully utilize the processing capacity of an imaging device and appropriately distribute the load to other devices.

### Means of Solving the Problem

An image processing system according to an aspect of the disclosure includes an imaging device and a terminal device, wherein, the imaging device includes an imaging unit configured to capture an image and generate image data indicating the image; a division processing unit configured to divide the image into a processible image and a target image when a processing load of image processing executed on the image is more than a predetermined load; a first image processing unit configured to execute the image processing on the processible image; and a transmitting unit configured to transmit a first image processing result and target image data indicating the target image to the terminal device, the first image processing result being a result of the image processing executed on the processible image; and the terminal device includes a receiving unit configured to receive the first image processing result and the target image data; a second image processing unit configured to execute the image processing on the target image indicated by the target image data; and an acquiring unit configured to acquire one result by integrating the first image processing result and a second image processing result being a result of the image processing executed on the target image.

An imaging device according to an aspect of the disclosure includes an imaging unit configured to capture an image and generate image data indicating the image; a division processing unit configured to divide the image into a processible image and a target image when a processing load of image processing executed on the image is more than a predetermined load; an image processing unit configured to execute the image processing on the processible image; and a transmitting unit configured to transmit an image processing result and target image data indicating the target image to a terminal device, the image processing result being a result of the image processing executed on the processible image.

### Effects of the Invention

According to one or more aspects of the disclosure, the processing capacity of an imaging device can be fully utilized, and the load can be appropriately distributed to other devices.

### BRIEF DESCRIPTION OF THE DRAWINGS

FIG. 1 is a block diagram schematically illustrating a configuration of a monitoring camera system, which is an image processing system according to first and second embodiments.

FIG. 2 is a block diagram schematically illustrating a configuration of a division processing unit according to the first embodiment.

FIGS. 3A and 3B are block diagrams illustrating hardware configuration examples.

FIG. 4 is a schematic diagram for describing specific-person recognition processing.

FIG. 5 is a flowchart illustrating the operation of a monitoring camera according to the first embodiment.

FIG. 6 is a schematic diagram illustrating an example of an image.

FIG. 7 is a schematic diagram for explaining a first example of image division.

FIGS. 8A and 8B are schematic diagrams illustrating a divided image according to the first embodiment.

FIG. 9 is a flowchart illustrating the operation of a terminal device according to the first embodiment.

FIG. 10 is a block diagram schematically illustrating a configuration of a division processing unit according to a second embodiment.

FIG. 11 is a schematic diagram for explaining a second example of image division.

FIG. 12 is a schematic diagram illustrating a divided image according to the second embodiment.

### MODE FOR CARRYING OUT THE INVENTION

### First Embodiment

The present embodiment will now be described with reference to the drawings. In the drawings, the same reference numerals are assigned to portions that are the same.

The drawings are schematic, and the proportions, etc., of the respective dimensions are different from the actual ones. Therefore, the specific dimensions should be determined with reference to the following description. Moreover, it goes without saying that even among the drawings, there are parts where the relation or proportion of the dimensions of each other is different.

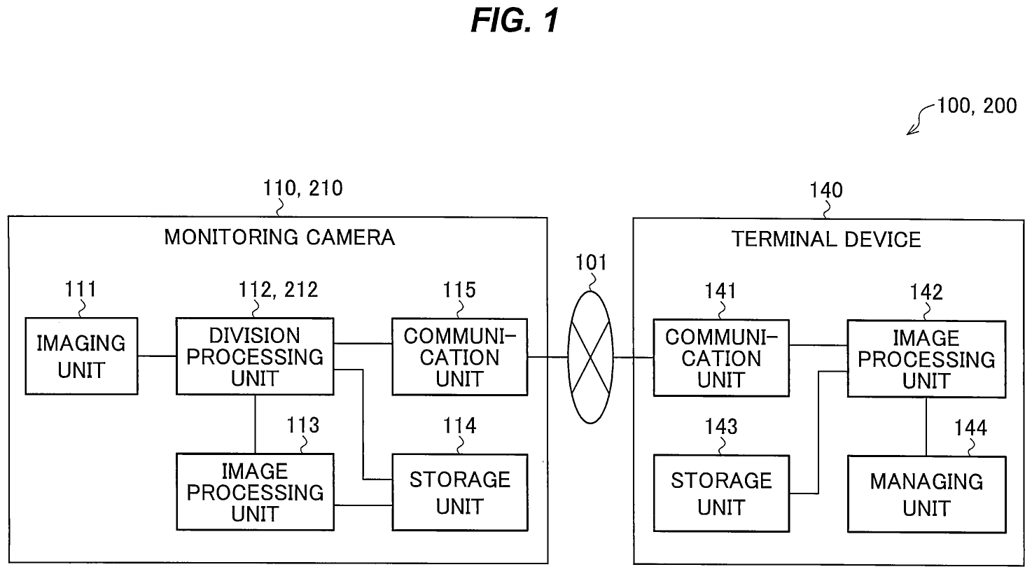

FIG. 1 is a block diagram schematically illustrating a configuration of a monitoring camera system 100, which is an image processing system according to the first embodiment.

The monitoring camera system 100 includes a monitoring camera 110 as an imaging device, and a terminal device 140.

The monitoring camera 110 and the terminal device 140 are connected to a network 101, and the image data of images captured by the monitoring camera 110 and the result of image processing executed at the monitoring camera 110 are sent to the terminal device 140. Control information and the like are sent from the terminal device 140 to the monitoring camera 110.

The monitoring camera 110 captures images of the surroundings of its installation site, executes predetermined image processing or image processing in accordance with the captured images or an instruction from the terminal device 140 and transmits the image data of the captured images and the image processing result to the terminal device 140.

The image processing result is, for example, coordinate information indicating rectangular regions containing people in an image or estimation result of objects captured in an image.

The monitoring camera 110 may be installed at a site remote from the terminal device 140.

As illustrated in FIG. 1, the monitoring camera 110 includes an imaging unit 111, a division processing unit 112, an image processing unit 113, a storage unit 114, and a communication unit 115.

The imaging unit 111 captures images and generates image data representing the captured images. For example, the imaging unit 111 includes an image sensor that captures images of the surrounding situation and an analog-to-digital (A/D) converter that converts the images into image data. The image data is given to the division processing unit 112.

The division processing unit 112 analyzes the image data from the imaging unit 111 to specify the image to be processed at the monitoring camera 110 in accordance with the processing load of when image processing is executed on the image data.

For example, when the processing load of image processing to be executed on an image indicated by image data is more than a certain load or a predetermined load, the division processing unit 112 divides the image into a processible image and a target image. The processible image is an image to be processed at the monitoring camera 110. The target image is an image to be processed by the terminal device 140 and is the remaining portion of the image obtained after separating the processible image from the image indicated by the image data.

Here, the certain load may be the load that can be allocated to image processing out of the total processing to be executed at the monitoring camera 110 or may be the load calculated at the moment from the total processing being executed at the monitoring camera 110 when image processing is being executed.

When the processing load is equal to or less than the predetermined load, the division processing unit 112 passes the image data from the imaging unit 111 to the image processing unit 113 without dividing the image data. In such a case, the image processing unit 113 executes image processing on the image indicated by the image data, and the communication unit 115 transmits the result of the image processing executed on the image indicated by the image data to the terminal device 140.

When the division processing unit 112 receives the image processing result from the image processing unit 113, the division processing unit 112 generates image-processing result data indicating the image processing result and causes the communication unit 115 to transmit the generated image-processing result data to the terminal device 140.

When the processing load is large and the image is divided, the division processing unit 112 generates processing instruction data including target image data indicating the target image, which is the image remaining after separating the processible image from the image indicated by the image data, and image-processing content data indicating the content of the image processing, and causes the communication unit 115 to transmit the processing instruction data to the terminal device 140.

When the image processing to be executed is predetermined, the image-processing content data indicating the content of the image processing needs not be transmitted to the terminal device 140.

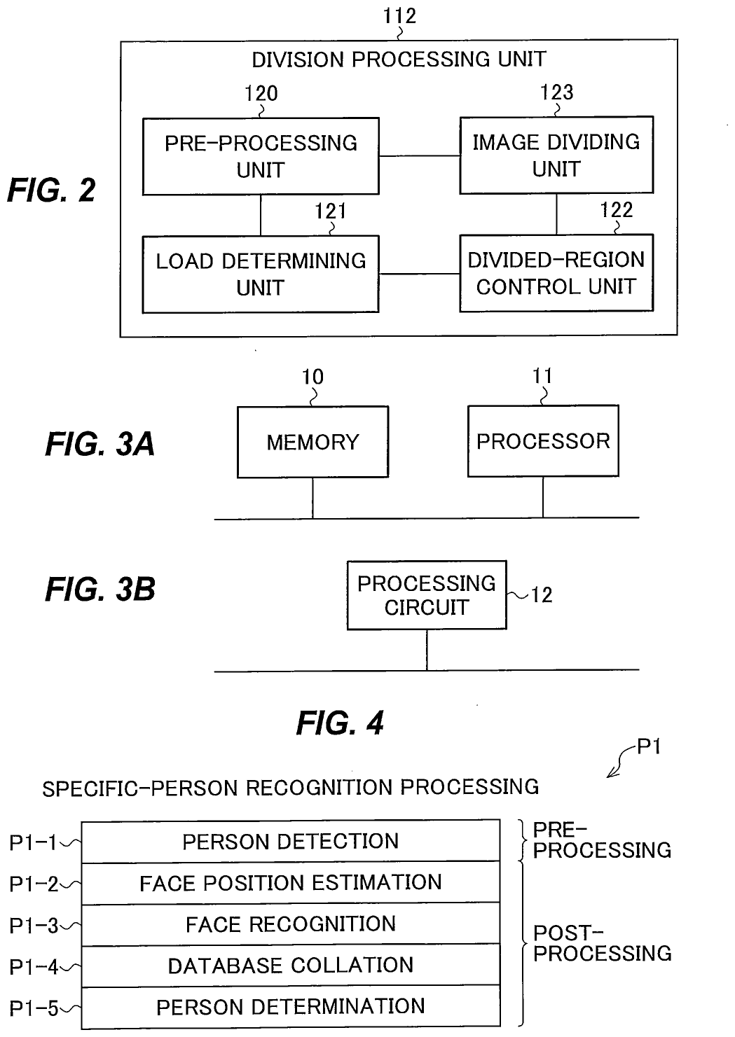

FIG. 2 is a block diagram schematically illustrating a configuration of the division processing unit 112.

The division processing unit 112 includes a pre-processing unit 120, a load determining unit 121, a divided-region control unit 122, and an image dividing unit 123.

The pre-processing unit 120 executes pre-processing necessary for the image processing unit 113 to execute image processing on the image indicated by the image data from the imaging unit 111 and passes the result of the pre-processing, or pre-processing result, to the load determining unit 121. The result of the pre-processing is used to determine the processing load of the image processing.

On the basis of the pre-processing result from the pre-processing unit 120, the load determining unit 121 determines whether or not the processing load, that is the load of when image processing is executed, is more than a predetermined load.

For example, when the imaging unit 111 captures an image including one or more subjects, the load determining unit 121 determines that the processing load is more than a predetermined load when the number of subjects exceeds a threshold.

When the processing load is determined to be more than a predetermined load, the divided-region control unit 122 determines how to divide the image indicated by the image data. The divided-region control unit 122 then instructs the image dividing unit 123 to divide the image in accordance with the determination. The division instruction includes a division method that indicates how to divide the image.

For example, when the processing load is more than a predetermined load, the divided-region control unit 122 determines to divide the image indicated by the image data into a processible image and a target image.

Here, the divided-region control unit 122 determines the processible image to be separated from the image indicated by the image data so that the image processing to be executed on the processible image is completed within a predetermined time.

For example, the divided-region control unit 122 determines the processible image to be separated from the image indicated by the image data so that the number of subjects contained in the processible image is a predetermined number out of the one or more subjects contained in the image indicated by the image data.

The image dividing unit 123 processes image data in accordance with an instruction from the divided-region control unit 122.

For example, when the instruction from the divided-region control unit 122 is an instruction to perform division, the image dividing unit 123 divides the image indicated by the image data into a processible image and a target image in accordance with the instruction and generates processible-image data indicating the processible image and target image data indicating the target image. The generated target image data is given to the image processing unit 113.

When the instruction from the divided-region control unit 122 is to not perform division, the image dividing unit 123 gives the image data from the imaging unit 111 to the image processing unit 113.

Referring back to FIG. 1, the image processing unit 113 executes image processing on the processible image indicated by the processible-image data from the division processing unit 112 or the image indicated by the image data from the imaging unit 111. Image processing may be executed in a single step or in multiple steps. The image processing unit 113 then gives the result of the image processing, or image processing result, to the division processing unit 112. The image processing unit 113 is also referred to as “first image processing unit,” and the result of image processing executed by the image processing unit 113 on the processible image is also referred to as “first image processing result.”

The storage unit 114 stores programs and data necessary for the processing executed at the monitoring camera 110.

The communication unit 115 communicates with the terminal device 140 via the network 101. For example, the communication unit 115 functions as a transmitting unit that transmits the first image processing result, which is the result of the image processing executed on the processible image, and the target image data to the terminal device 140. The communication unit 115 also functions as a transmitting unit that transmits the result of the image processing executed on the image indicated by the image data from the imaging unit 111 to the terminal device 140.

A portion or the entirety of the division processing unit 112 and the image processing unit 113 described above can be implemented by, for example, a memory 10 and a processor 11, such as a central processing unit (CPU), that executes the programs stored in the memory 10, as illustrated in FIG. 3A. Such programs may be provided via a network or may be recorded and provided on a recording medium. That is, such programs may be provided as, for example, program products.

A portion or the entirety of the division processing unit 112 and the image processing unit 113 can be implemented by, for example, a processing circuit 12, such as a single circuit, a composite circuit, a programmed processor, a parallel programmed processor, an application specific integrated circuit (ASIC), or a field programmable gate array (FPGA), as illustrated in FIG. 3B.

As described above, the division processing unit 112 and the image processing unit 113 can be implemented by circuitry.

The storage unit 114 can be implemented by a storage, such as a volatile or a non-volatile memory.

The communication unit 115 can be implemented by a communication interface, such as a network interface card (NIC).

Referring back to FIG. 1, the terminal device 140 is a device that records image data transmitted from the monitoring camera 110 via the network 101 on a storage medium not illustrated in FIG. 1 or displays images to users by using a monitor. Moreover, the terminal device 140 receives the target image data and the image-processing content data transmitted from the monitoring camera 110 and executes processing corresponding to the processing content indicated by the image-processing content data on the received target image data.

As illustrated in FIG. 1, the terminal device 140 includes a communication unit 141, an image processing unit 142, a storage unit 143, and a managing unit 144.

The communication unit 141 communicates with the monitoring camera 110 via the network 101. For example, the communication unit 141 functions as a receiving unit that receives the target image data and the first image processing result or the result of the image processing executed on the processible image at the monitoring camera 110.

The image processing unit 142 executes predetermined processing on image data. The predetermined processing includes processing of the processing content indicated by the image-processing content data transmitted from the monitoring camera 110 in addition to the processing scheduled to be executed by the terminal device 140.

For example, the image processing unit 142 executes image processing on the target image indicated by the target image data. Here, the image processing unit 142 is also referred to as “second image processing unit,” and the result of image processing executed on the target image is also referred to as “second image processing result.”

The storage unit 143 stores programs and data necessary for the processing executed by the terminal device 140.

The managing unit 144 manages the overall operation of the terminal device 140. The overall operation includes, in addition to recording the image data received by the communication unit 141 on an appropriate storage medium (not illustrated) and instructing the display to users, instructing the image processing unit 142 to execute the image processing indicated by the image-processing content data on the received target image data when the communication unit 141 receives the processing instruction data including the target image data and the image-processing content data from the monitoring camera 110.

The managing unit 144 functions as an acquiring unit that acquires one result by integrating the first image processing result, which is the result of image processing executed on the processible image at the monitoring camera 110, with the second image processing result, which is the result of image processing executed on the target image.

The image processing results integrated into one result can be treated as a result equivalent to that obtained when image processing is executed by the image processing unit 113 without dividing the image data captured by the imaging unit 111.

A portion or the entirety of the image processing unit 142 and the managing unit 144 described above can also be implemented by, for example, a memory 10 and a processor 11, such as a CPU, that executes the programs stored in the memory 10, as illustrated in FIG. 3A. Such programs may be provided via a network or may be recorded and provided on a recording medium. That is, such programs may be provided as, for example, program products. In other words, the terminal device 140 can be implemented by a computer.

A portion or the entirety of the image processing unit 142 and the managing unit 144 can be implemented by, for example, a processing circuit 12, such as a single circuit, a composite circuit, a programmed processor, a parallel programmed processor, an ASIC, or an FPGA, as illustrated in FIG. 3B.

As described above, the image processing unit 142 and the managing unit 144 can be implemented by circuitry.

The storage unit 143 can be implemented by a storage, such as a volatile or a non-volatile memory.

The communication unit 141 can be implemented by a communication interface, such as an NIC.

Now will be described an outline of monitoring processing as system processing executed by the monitoring camera system 100 according to the first embodiment.

Here, the monitoring processing is, for example, specific-person recognition processing P1, as illustrated in FIG. 4. The specific-person recognition processing P1 consists of person detection P1-1 for detecting a person, face position estimation P1-2 for estimating the position of the detected person's face, face recognition P1-3 for recognizing the detected person's face, database collation P1-4 for collating the recognized face of the detected person with faces stored in a database, and person determination P1-5 for determining whether or not the detected person is a specific person on the basis of the collation result.

The specific-person recognition processing P1 extracts the face of a person from image data and determines whether or not the corresponding person is in the database stored in advance. In the following, the specific-person recognition processing P1 will be used as an example of monitoring processing, but the present embodiment is not limited to such an example.

Here, in the specific-person recognition processing P1, the face position estimation P1-2, the face recognition P1-3, the database collation P1-4, and the person determination P1-5 are defined as image processing, and the person detection P1-1 is defined as pre-processing for estimating the processing load of the image processing (P1-2 to P1-5), which is post-processing. However, the pre-processing of the present embodiment is not limited to the person detection P1-1, and any processing can be executed so long as the processing load of image processing can be determined.

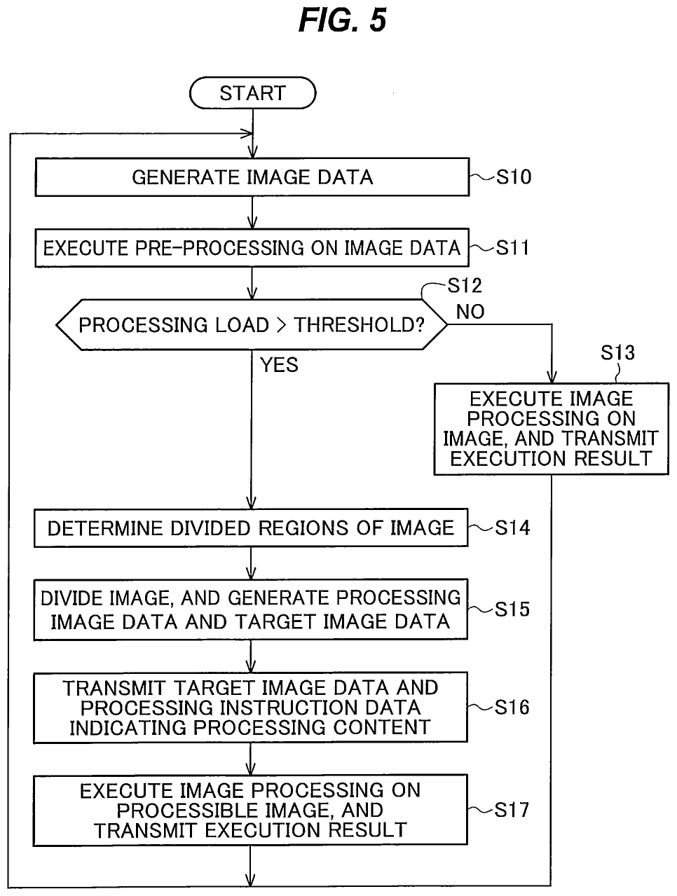

FIG. 5 is a flowchart illustrating the operation of the monitoring camera 110 according to the first embodiment.

First, the imaging unit 111 generates image data by converting signals obtained by the image sensor into the image data (step S10). The imaging unit 111 passes the image data to the division processing unit 112.

The pre-processing unit 120 of the division processing unit 112 executes the person detection P1-1 as pre-processing on the image data from the imaging unit 111 (step S11).

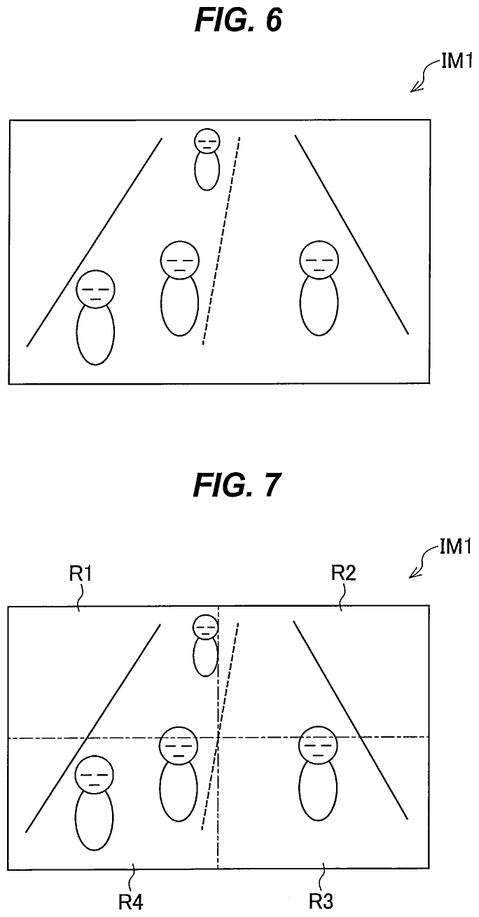

For example, when the image data indicates an image IM1 illustrated in FIG. 6, the pre-processing unit 120 detects the number and position of people as a result of executing the person detection P1-1. In the example of FIG. 6, four people and the positions of the four people are detected.

As the person detection P1-1, generally well-known techniques may be used, such as person detection using histograms of oriented gradients (HOG) features or person detection using Haar-like features.

Here, the pre-processing unit 120 divides the image IM1 into multiple predetermined regions, or four regions R1 to R4, as illustrated in FIG. 7, and detects the people and their positions in each of the regions R1 to R4. The pre-processing unit 120 then specifies the number of people in the image IM1 on the basis of the people detected in the respective regions R1 to R4.

Next, the load determining unit 121 determines whether or not the processing load of image processing on the image data is more than a certain threshold on the basis of the detection result from the pre-processing unit 120 (step S12). Here, by setting the threshold to a processing load of image processing on image data that is completed within a predetermined time or within a time estimated to be allocated to the image processing on the image data out of the overall processing executed at the monitoring camera 110 when the image processing is executed, it is determined whether or not the image processing on the image data is completed within the predetermined time. Specifically, the determination is made on the basis of whether or not the number of people detected by the pre-processing unit 120 is more than a predetermined number of people, or a threshold. For example, as illustrated in FIG. 7, the determination may be made on the basis of whether or not the density of people in any of the regions R1 to R4 obtained by dividing the image IM1 is higher than a predetermined threshold.

Then, if the processing load is equal to or less than the threshold (No in step S12), the processing proceeds to step S13, and if the processing load is more than the threshold (Yes in step S12), the processing proceeds to step S14.

In step S13, since the image processing is determined to be completed within the predetermined time, the divided-region control unit 122 instructs the image dividing unit 123 to directly give the image data obtained by the imaging unit 111 to the image processing unit 113. The image processing unit 113 then executes image processing on the image indicated by the image data. Here, the image processing unit 113 performs the face position estimation P1-2, the face recognition P1-3, the database collation P1-4, and the person determination P1-5 of the specific-person recognition processing P1 on the image indicated by the image data without performing the pre-processing. It is assumed that the database used for the database collation P1-4 is stored in the storage unit 114. The image processing unit 113 then gives the execution result of the image processing or the image processing result to the divided-region control unit 122, and the divided-region control unit 122 generates image-processing result data indicating the image processing result and causes the communication unit 115 to transmit the image-processing result data to the terminal device 140.

Meanwhile, in step S14, since it is determined that the image processing will not be completed within the predetermined time, the divided-region control unit 122 determines to divide the image indicated by the image data into an image of a region that can be processed, or a processible image, and an image of the region other than the processible image, or a target image, and determines the respective regions of the processible image and the target image.

For example, when the pre-processing unit 120 performs the person detection P1-1 after dividing the image into the predetermined regions R1 to R4 as illustrated in FIG. 7, the divided-region control unit 122 needs only to determine the processible image so that the number of people included in the processible image is equal to or smaller than a predetermined threshold. Specifically, when the threshold is “one person,” the divided-region control unit 122 needs only to set the images of regions R1 and R2 as processible images and the regions R3 and R4 as target images. Alternatively, the images of regions R2 and R3 may be set as processible images, but here, the horizontal regions have priority over the vertical ones.

In detail, the divided-region control unit 122 specifies the region containing the smallest number of people as a determination region and determines whether or not the number of people in the determination region is equal to or smaller than the threshold. When the number of people in the determination region is equal to or smaller than the threshold, the divided-region control unit 122 expands the determination region by adding a region containing the smallest number of people of the regions adjacent to the determination region, and similarly determines whether or not the number of people in the determination region is equal to or smaller than the threshold. The divided-region control unit 122 repeats the above processing to define as a processible image the range of the largest image in which the number of people contained in the determination region is equal to or smaller than the threshold.

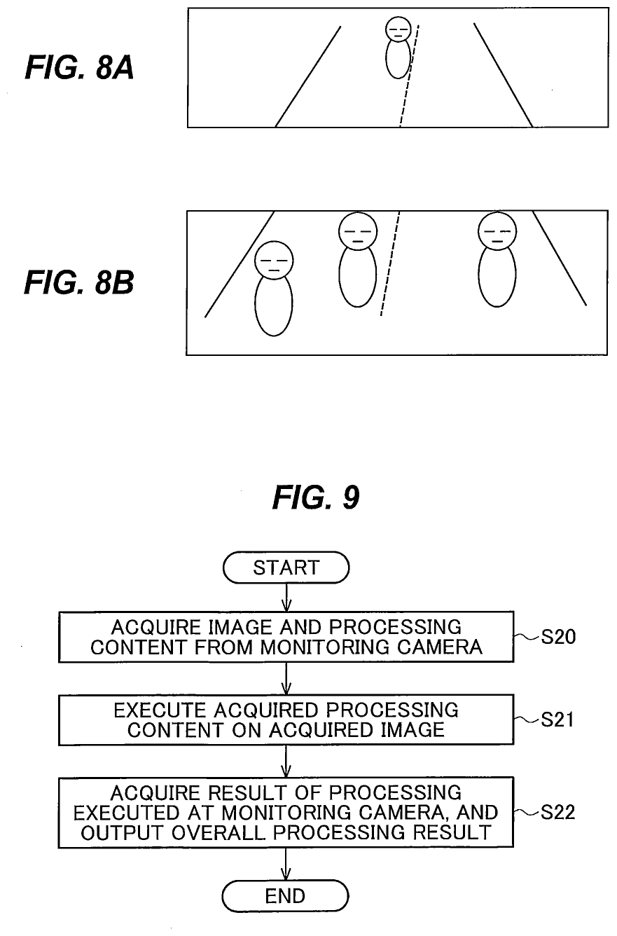

Next, the image dividing unit 123 divides the image indicated by the image data from the imaging unit 111 into a processible image and a target image in accordance with the determination by the divided-region control unit 122 and generates processible-image data indicating the processible image and target image data indicating the target image (step S15). For example, the image dividing unit 123 defines the image illustrated in FIG. 8A as the processible image and the image illustrated in FIG. 8B as the target image. The processible-image data is given to the image processing unit 113.

The divided-region control unit 122 then causes the communication unit 115 to transmit processing instruction data including target image data indicating the target image and image-processing content data indicating the content of image processing to the terminal device 140 (step S16). For example, the divided-region control unit 122 needs only to generate image-processing content data indicating the number and position of people obtained as a result of the person detection P1-1 performed by the pre-processing unit 120 and the processing content of the face position estimation P1-2, the face recognition P1-3, the database collation P1-4, and the person determination P1-5 of the specific-person recognition processing P1 without performing the pre-processing. The processing content may be a program describing the processing to be executed, or a symbol or a character string designating the corresponding program if the terminal device 140 holds the program describing the processing to be executed.

When the image processing unit 113 receives the processible-image data, the image processing unit 113 executes image processing on the processible-image data and gives the result of the image processing, or the image processing result, to the divided-region control unit 122. The divided-region control unit 122 generates image-processing result data indicating the image processing result and causes the communication unit 115 to transmit the image-processing result data to the terminal device 140 (step S17).

FIG. 9 is a flowchart illustrating the operation of the terminal device 140 according to the first embodiment.

Here, illustrated is the operation by the terminal device 140 when an image is divided at the monitoring camera 110.

First, the communication unit 141 receives processing instruction data from the monitoring camera 110 and gives the processing instruction data to the image processing unit 142 (step S20).

The image processing unit 142 performs the face position estimation P1-2, the face recognition P1-3, the database collation P1-4, and the person determination P1-5 of the specific-person recognition processing P1 without performing the pre-processing on the target image indicated by the target image data included in the processing instruction data for the number and position of people indicated by the image-processing content data included in the processing instruction data, and obtains the result of the image processing on the target image, or the image processing result (step S21). The image processing result of the target image is given to the managing unit 144. It is assumed that the database for performing the database collation P1-4 is stored in the storage unit 143.

The communication unit 141 receives the image-processing result data from the monitoring camera 110 and gives the image-processing result data to the managing unit 144. The managing unit 144 then combines the image processing result indicated by the image-processing result data from the communication unit 141 with the image processing result of the target image and integrates them into one image processing result.

The image processing result integrated into one result can be treated as a result equivalent to the result of the specific-person recognition processing P1 executed on the original image data (step S22).

As explained above, the monitoring camera system 100 can appropriately execute processing that can be executed at the monitoring camera 110 and then share the load with the terminal equipment 140.

According to the monitoring camera system 100 according to the first embodiment described above, image data is divided in accordance with the processing capacity of the monitoring camera 110 to enable appropriate allocation of the processing to be executed at the monitoring camera 110, regardless of the processing load required for the processing to be executed.

With the monitoring camera system 100 according to the first embodiment, since image data can be divided into regions in accordance with the load of the processing that can be executed at the monitoring camera 110, the processing capacity of the monitoring camera 110 can be utilized effectively.

With the monitoring camera system 100 according to the first embodiment, no delay in network transmission occurs in the regions of image data to be executed at the monitoring camera 110, and processing can be executed in real time as in the case where image data is not divided. This makes it possible to continue processing without delay even when image processing is executed using the result of processing of previous images.

With the monitoring camera system 100 according to the first embodiment, since the regions of the image data to be executed at the monitoring camera 110 are not transmitted over the network 101, it is possible to establish a setting to execute processing for the portion that requires privacy within the monitoring camera 110.

With the monitoring camera system 100 according to the first embodiment, since the regions of the image data to be executed at the monitoring camera 110 are not transmitted over the network 101, advanced image processing can be achieved even in an environment where the amount of network transmission is suppressed and the bandwidth of the network is insufficient.

With the monitoring camera system 100 according to the first embodiment, since the regions of the image data to be executed at the monitoring camera 110 are not transmitted over the network 101, advanced image processing can be achieved even if the performance of the terminal device is low, in comparison with a case in which the entire image processing is executed at the terminal device.

### Second Embodiment

As illustrated in FIG. 1, a monitoring camera system 200, which is an image processing system, according to the second embodiment includes a monitoring camera 210 and a terminal device 140.

The terminal device 140 of the monitoring camera system 200 according to the second embodiment is the same as the terminal device 140 of the monitoring camera system 100 according to the first embodiment.

As illustrated in FIG. 1, the monitoring camera 210 includes an imaging unit 111, a division processing unit 212, an image processing unit 113, a storage unit 114, and a communication unit 115.

The imaging unit 111, the image processing unit 113, the storage unit 114, and the communication unit 115 of the monitoring camera 210 according to the second embodiment are respectively the same as the imaging unit 111, the image processing unit 113, the storage unit 114, and the communication unit 115 of the monitoring camera 110 according to the first embodiment.

The division processing unit 212 analyzes image data from the imaging unit 111 to divide the image to be processed at the monitoring camera 210 in accordance with the processing load of when image processing is executed on the image data.

In the second embodiment, as in the first embodiment, the specific-person recognition processing P1 illustrated in FIG. 4 is executed as system processing for the explanation.

In general, the face recognition P1-3 and the database collation P1-4 of the specific-person recognition processing P1 become more difficult as the number of pixels occupying the image to be processed becomes small. For this reason, it is necessary to improve the processing accuracy by, for example, expanding the image to a size that can be processed or executing the processing multiple times, which increases the processing load.

Therefore, in the second embodiment, the division processing unit 212 distributes the processing load by dividing an image into a processible image corresponding to a region capturing an image of the vicinity of the monitoring camera 110 and a target image corresponding to a region remote from the monitoring camera 110.

For example, the division processing unit 212 separates the processible image from the image indicated by the image data so that a predetermined number of subjects is contained in the processible image in order from the subject close to the imaging unit 111 out of the one or more subjects included in the image.

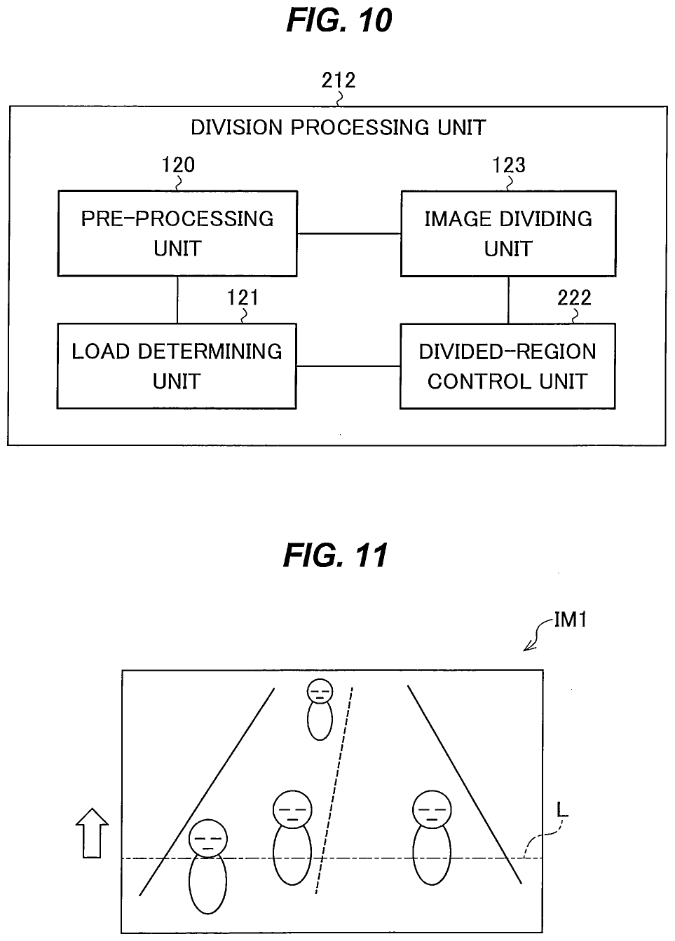

FIG. 10 is a block diagram schematically illustrating a configuration of the division processing unit 212 according to the second embodiment.

The division processing unit 212 includes a pre-processing unit 120, a load determining unit 121, a divided-region control unit 222, and an image dividing unit 123.

The pre-processing unit 120, the load determining unit 121, and the image dividing unit 123 of the division processing unit 212 according to the second embodiment are respectively the same as the pre-processing unit 120, the load determining unit 121, and the image dividing unit 123 of the division processing unit 112 according to the first embodiment.

When the processing load is more than a predetermined load, in other words, when the load determining unit 121 determines that the image processing is not to be completed within a predetermined time at the monitoring camera 210, the divided-region control unit 222 determines how to divide the image data in accordance with the distance to the people detected by the pre-processing unit 120. The divided-region control unit 122 then instructs the image dividing unit 123 in accordance with the determination.

In general, the monitoring camera 210 is fixed in place, not carried. Therefore, the distance to a person in an image captured by the monitoring camera 210 can be specified on the basis of the location where the monitoring camera 210 is installed.

For example, as illustrated in FIG. 6, when the monitoring camera 210 captures an image of the ground obliquely from above, the lower portion of the image IM1 is close, and the upper portion of the image is far. Therefore, the divided-region control unit 222 can roughly specify the distance to a person on the basis of the position of the person captured in the image.

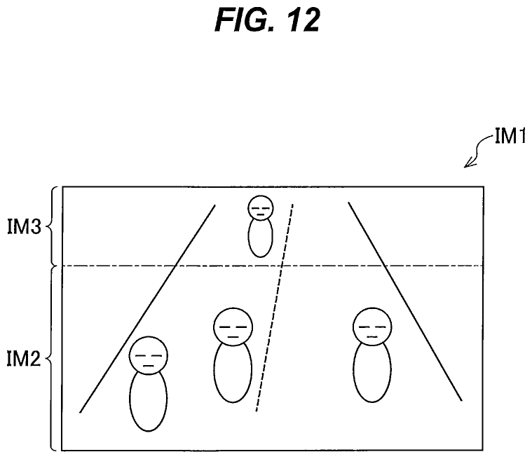

For example, when the lower portion of the image is at a closer distance as described above, the divided-region control unit 222 can move a boundary L for dividing the image IM1 upward from the lower edge of the image IM1, as illustrated in FIG. 11, so that a maximum region containing a number of people that can be processed by the monitoring camera 210 is defined as a processible image and the remaining portion of the image is defined as a target image.

When the number of people that can be processed by the monitoring camera 210 is, for example, three, the divided-region control unit 222 can determine to divide the image IM1 into an image IM2 corresponding to a region containing three people as a processible image and an image IM3 corresponding to the remaining region as a target image, as illustrated in FIG. 12. In accordance with such determination, the image dividing unit 123 needs only to divide the image IM1 and generate processible-image data indicating the processible image and target image data indicating the target image.

As described above, according to the second embodiment, even when the processing load depends on the proportion of the subjects to be processed in the image, the load can be appropriately distributed.

In the second embodiment, if the monitoring camera 210 includes a distance sensor (not illustrated) for measuring the distance to a person, the divided-region control unit 222 may determine how to divide an image on the basis of the detection result by the distance sensor.

In the above described first and second embodiments, the specific-person recognition processing P1 is executed as system processing executed by the monitoring camera systems 100 and 200, but the first and second embodiments are not limited to such examples.

For example, eye catch counting may be performed as system processing. In such a case, the pre-processing unit 120 performs the same person detection as above as pre-processing, and the image processing units 113 and 142 need only to perform, as image processing, face position estimation to estimate the position of a detected person's face, facial feature estimation to estimate the features of the detected person's face, and face orientation detection to detect the orientation of the detected person's face.

Suspicious behavior analysis may be performed as system processing. In such a case, the pre-processing unit 120 needs only to perform the same person detection as above as pre-processing, and the image processing units 113 and 142 need only to perform, as image processing, skeleton detection to detect the detected person's skeleton, behavior analysis to analyze the behavior of the detected person from this skeleton, and suspicious behavior detection to detect suspicious behavior from the behavior of the detected person.

Furthermore, misplaced or forgotten item detection may be performed as system processing. In such a case, the pre-processing unit 120 needs only to perform as pre-processing, misplaced item detection to detect a misplaced item, and the image processing units 113 and 142 need only to perform, as image processing, object estimation to estimate what the detected object is, and notification processing to notify a predetermined destination, such as a facility, of a misplaced item. The misplaced item detection needs only to be performed, for example, through comparison with an image provided in advance.

### DESCRIPTION OF REFERENCE CHARACTERS

100, 200 monitoring camera system; 110, 210 monitoring camera; 111 imaging unit; 112, 212 division processing unit; 113 image processing unit; 114 storage unit; 115 communication unit; 120 pre-processing unit; 121 load determining unit; 122, 222 divided-region control unit; 123 image dividing unit; 140 terminal device; 141 communication unit; 142 image processing unit; 143 storage unit; 144 managing unit.

1. An image processing system comprising an imaging device and a terminal device, wherein,
the imaging device comprises:
an image sensor to capture an image;
an analog-to-digital converter to generate image data indicating the image;
first processing circuitry to divide the image into a processible image and a target image when a processing load of image processing to be executed on the image is more than a predetermined load
and to execute the image processing on the processible image; and
a first communication interface to transmit a first image processing result and target image data indicating the target image to the terminal device, the first image processing result being a result of the image processing executed on the processible image, and
the terminal device comprises:
a second communication interface to receive the first image processing result and the target image data; and
a second processing circuitry to execute the image processing on the target image indicated by the target image data and
to acquire one result by integrating the first image processing result and a second image processing result being a result of the image processing executed on the target image.

2. The image processing system according to claim 1, wherein when the processing load is equal to or less than the predetermined load, the first processing circuitry executes the image processing on the image, and the first communication interface transmits a result of the image processing executed on the image to the terminal device.

3. The image processing system according to claim 1, wherein the target image is an image remaining after separating the processible image from the image.

4. The image processing system according to claim 1, wherein the first processing circuitry separates the processible image from the image to allow the image processing executed on the processible image to be completed within a predetermined time.

5. The image processing system according to claim 1, wherein,
the image sensor captures the image to include one or more subjects in the image, and
the first processing circuitry determines that the processing load is more than the predetermined load when the number of subjects is greater than a threshold, the subjects being the one or more subjects.

6. The image processing system according to claim 5, wherein the first processing circuitry separates the processible image from the image in such a manner that the number of subjects included in the processible image out of the one of more subjects is a predetermined number.

7. The image processing system according to claim 6, wherein the first processing circuitry separates the processible image from the image in such a manner that the predetermined number of subjects out of the one of more subjects is included in the processible image in order from a subject close to the imaging unit.

8. The image processing system according to claim 1, wherein the first processing circuitry determines whether or not the processing load is more than the predetermined load based on a result of executing pre-processing necessary for executing the image processing on the image.

9. An imaging device comprising:
an image sensor to capture an image;
an analog-to-digital converter to generate image data indicating the image;
a processing circuitry to divide the image into a processible image and a target image when a processing load of image processing to be executed on the image is more than a predetermined load
and to execute the image processing on the processible image; and
a communication interface to transmit an image processing result and target image data indicating the target image to a terminal device, the image processing result being a result of the image processing executed on the processible image.

10. The imaging device according to claim 9, wherein when the processing load is equal to or less than the predetermined load, the processing circuitry executes the image processing on the image, and the communication interface transmits a result of the image processing executed on the image to the terminal device.

11. The imaging device according to claim 9, wherein the target image is an image remaining after separating the processible image from the image.

12. The imaging device according to claim 9, wherein the processing circuitry separates the processible image from the image to allow the image processing executed on the processible image to be completed within a predetermined time.

13. The imaging device according to claim 9, wherein,
the image sensor captures the image to include one or more subjects in the image, and
the processing circuitry determines that the processing load is more than the predetermined load when the number of subjects is greater than a threshold, the subjects being the one or more subjects.

14. The imaging device according to claim 13, wherein the processing circuitry separates the processible image from the image in such a manner that the number of subjects included in the processible image out of the one of more subjects is a predetermined number.

15. The imaging device according to claim 14, wherein the processing circuitry separates the processible image from the image in such a manner that the predetermined number of subjects out of the one of more subjects is included in the processible image in order from a subject close to the imaging unit.

16. The imaging device according to claim 9, wherein the processing circuitry determines whether or not the processing load is more than the predetermined load based on a result of executing pre-processing necessary for executing the image processing on the image.

17. A terminal device comprising:
a communication interface to receive a first image processing result and a target image data, the first image processing result being a result of image processing executed on a processible image into which the image is divided when a processing load of the image processing to be executed on the image is more than a predetermined load, the target image data indicating a target image which is an image remaining after separating the processible image from the image; and
processing circuitry to execute the image processing on the target image indicated by the target image data and to acquire one result by integrating the first image processing result and a second image processing result being a result of the image processing executed on the target image.

18. An image processing method comprising:
capturing an image;
generating image data indicating the image;
dividing the image into a processible image and a target image when a processing load of image processing to be executed on the image is more than a predetermined load;
executing the image processing on the processible image; and
transmitting an image processing result and target image data indicating the target image to a terminal device, the image processing result being a result of the image processing executed on the processible image.
